(19) United States
(12) Patent Application Publication
(10) Pub. No.: US 2018/0311925 A1
(43) Pub. Date: Nov. 1, 2018

(54) CELLULAR STRUCTURE

(71) Applicant: FORD GLOBAL TECHNOLOGIES, LLC, Dearborn, MI (US)

(72) Inventors: Tau TYAN, Northville, MI (US); Yu-Kan HU, Ypsilanti, MI (US); Leonard Anthony SHANER, New Baltimore, MI (US)

(21) Appl. No.: 15/498,225

(22) Filed: Apr. 26, 2017

(51) Int. Cl. B32B 3/12

(52) U.S. Cl. CPC B32B 3/12

(57) ABSTRACT

A cellular structure includes a plurality of walls extending in a longitudinal direction and forming a plurality of cells adjacently arranged along a laterally extending plane. Each cell has a cross-section along the plane that includes eighteen sides formed by the plurality of walls. The eighteen sides of each cell are joined to each other to form a closed loop and six outward extending lobes.

### TECHNICAL FIELD

The present disclosure relates to cellular structures.

### BACKGROUND

Cellular structures are utilized in several industries to improve structural integrity of a given product and/or to protect individuals that may be using or operating a given product.

### SUMMARY

A cellular structure includes a web of cells having shared walls. The cells each including six lobes that are formed by the shared walls and joined to each other to form a closed loop. Each lobe has three planar sections forming two external corners. Each cell has six internal corners formed by the ends of adjacent lobes.

A cellular structure includes a plurality of walls extending in a longitudinal direction and forming a plurality of cells adjacently arranged along a laterally extending plane. Each cell has a cross-section along the plane that includes eighteen sides formed by the plurality of walls. The eighteen sides of each cell are joined to each other to form a closed loop and six outward extending lobes.

A cellular cell structure includes a plurality of walls extending in a longitudinal direction and forming a cross-sectional area on a laterally extending plane. The cross-sectional area including eighteen sides formed by the plurality of walls. The eighteen sides are joined to each other to form a closed loop and six outward extending lobes.

### BRIEF DESCRIPTION OF THE DRAWINGS

FIG. 1 is a perspective view of a cellular structure;

FIG. 2 is a top view of the cellular structure;

FIG. 3 is a top view of a second embodiment of the cellular structure;

FIG. 4 is a top view of a third embodiment of the cellular structure;

FIG. 5 is a side view of an alternative embodiment of an individual cell of the cellular structure;

FIG. 6 is a top view of the alternative embodiment of the individual cell;

FIG. 7 is a cross-sectional view of the alternative embodiment of the individual cell taken along line 7-7 in FIG. 5;

FIG. 8 illustrates a perspective view of an exemplary embodiment of a sandwich structure employing the cellular structure; and

FIG. 9 illustrates a perspective cutaway view of the exemplary embodiment of the sandwich structure.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

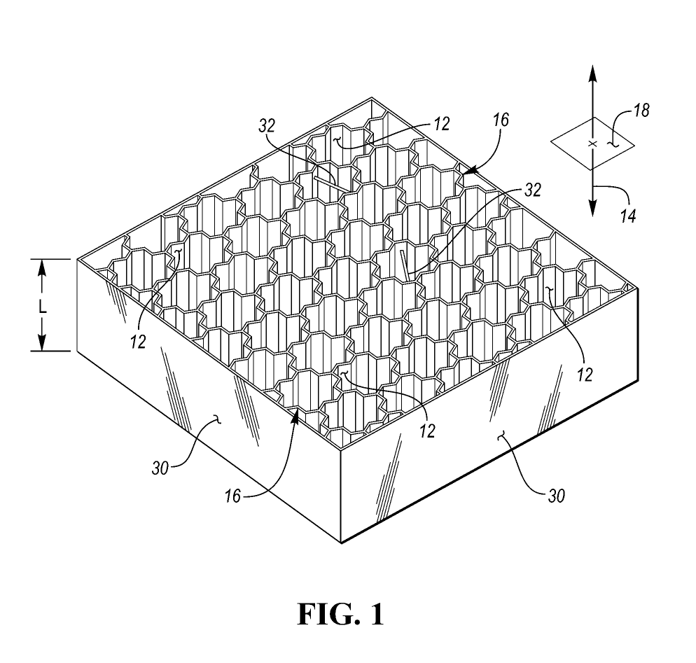

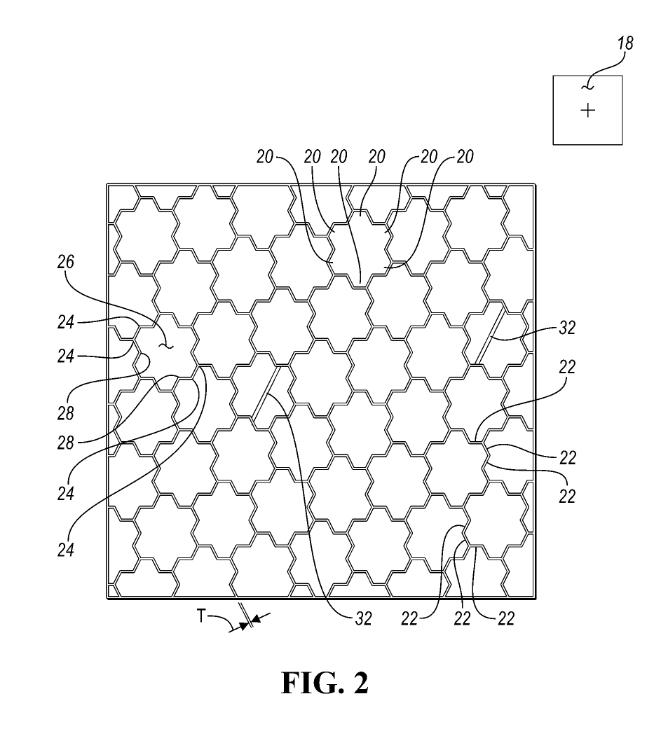

Referring to FIGS. 1 and 2, a perspective view and a top view of a cellular structure 10 are illustrated, respectively. The cellular structure 10 includes a plurality of walls 12 extending in a longitudinal direction 14. The plurality of walls 12 form a plurality of adjacently arranged cells 16 that are arranged along a laterally extending plane 18 (alternatively, it may be stated that the cellular structure 10 has a web of cells 16 that have shared walls 12). The laterally extending plane 18 may be substantially perpendicular to the longitudinal direction 14. Substantially perpendicular may refer to any incremental value that ranges from 85° to 95°. Each cell 16 has a cross-section (or cross-sectional area) along the laterally extending plane 18 that includes eighteen sides that are formed by the plurality of walls 12.

The eighteen sides of each cell 16 are joined to each other to form a closed loop and six outward extending lobes 20. Each lobe 20 of each cell 16 is formed by three of the eighteen sides. The six lobes 20 of each cell 16 may be radially spaced relative to each other about a center of each cell 16 along the laterally extending plane 18. The six lobes 20 of each cell 16 may be radially spaced substantially evenly about the center of each cell 16 along the laterally extending plane 18. Radially spaced substantially evenly about the center of each cell 16 may refer to adjacent lobes 20 of each cell 16 being spaced at any incremental value that ranges from 55° to 65°, where the sum of the total spacing between the adjacent lobes 20 of the six lobes 20 of each cell 16 is 360°.

Each lobe 20 of each cell 16 is formed by three planar sections 22, the three planar sections 22 being three of the eighteen sides of each cell 16. The plurality of walls 12, which form the eighteen sides of each cell 16, may extending in one direction (i.e., the longitudinal direction 14), which may be a direction in which the cellular structure 10 is expected to receive an impact (i.e., an expected impact direction). The cross-section of each cell 16 may be oriented substantially perpendicular to the longitudinal direction 14 and the expected impact direction. Substantially perpendicular may refer to any incremental value that ranges from 85° to 95°.

The three planar sections 22 of each of the six lobes 20 of each cell 16 also form two external corners 24 that extend outward from a central space (or cavity) 26 defined by the eighteen sides of each cell 16. Each cell 16 also has six internal corners 28 that are formed by the ends of adjacent lobes 20 of each cell 16. The internal corners 28 extend inward toward the central space 26 of each cell 16. The external corners 24 and the internal corners 28 may have various bend radii.

Each cell 16 has a total of eighteen corners (twelve external corners 24 formed by the three planar sections 22 of each of the six lobes 20 and six internal corners 28 formed by the ends of adjacent lobes 20). Testing has indicated that cellular structures having eighteen cornered cells absorb more energy and require an increased force to displace the cellular structure along an expected impact direction when compared to cellular structures having either four or six cornered cells. Testing has further indicated that cellular structures having eighteen cornered cells absorb more energy and require an increased force to displace the cellular structure along an expected impact direction, while also having more regular crush patterns, smaller folding lengths, smaller dimensions, less material, a lower total mass and a lower total number cells, when compared to cellular structures having either four or six cornered cells.

Under quasi-static loading testing conditions, cellular structures having eighteen cornered cells were able to withstand higher quasi-static forces without exhibiting plastic or permanent deformation when compared to cellular structures having either four or six cornered cells. Under quasi-static loading conditions where plastic or permanent deformation occurred, the deformation of the cellular structures having eighteen cornered cells was less severe and more concentrated or localized when compared to cellular structures having either four or six cornered cells, resulting in a condition that was easier and less costly to repair when compared to cellular structures having either four or six cornered cells. To achieve similar performances in quasi-static loading conditions when compared to cellular structures having either four or six cornered cells, eighteen cornered cellular structures require a smaller design space, smaller dimensions, lower total number of cells, less material, and a lower total mass.

The plurality of walls 12 of each cell 16 may have a longitudinal length, L, and a thickness, T. A ratio between the longitudinal length, L, and the thickness, T, i.e., L/T, may be at least 1 to 100 (small L to large T ratios may be utilized in products such as shoe insoles, protective skins for phones or mobile devices, and/or backing or reinforcing ribs for molding or casting parts). The ratio between the longitudinal length, L, and the thickness, T, i.e., L/T, may be as great as 10,000 to 1 (Large L to small T ratios may be utilized in products such as composite or honeycomb materials). The plurality of walls 12 may maintain a constant or variable thicknesses, T, along the longitudinal length, L, of each cell 16 to control local or global properties (in-plan or out-of-plan stress, strain, stiffness, peak load, crush force, crush energy, deformation pattern) based on the desired application and/or in anticipation of expected loads whether they be local or global. Furthermore, the thickness of each individual side of the eighteen sides of each cell 16 may vary or may be fine-turned independently for desired local or global properties.

The central space 26 of one or more cells 16 of the cellular structure 10 may be filled with deformable structures or foam materials. The deformable structures or foam materials may increase the structural integrity of the cellular structure 10, increase the ability to absorb energy during an impact, or may be utilized for other desirable functions, such as thermal or sound insulation. Plates (or sheets) 30 may also be joined to the outside surfaces (top, bottom and four sides) of the cellular structure. Please note that a plate 30 is not shown on the top surface in FIG. 1 for illustrative purposes (i.e., so that the individual cells 16 may be observed). The plates 30 may also increase the structural integrity of the cellular structure 10, increase the ability to absorb energy during an impact, or may be utilized for other desirable functions, such as thermal or sound insulation. Internal support ribs 32 or webs may be disposed in the central space 26 of one or more cells 16 of the cellular structure 10. The internal support ribs 32 may be secured to at least two to the eighteen sides of each of the one or more cells 16 that include internal support ribs. The internal support ribs 32 may increase the structural integrity of the cellular structure 10 and/or increase the ability to absorb energy during an impact.

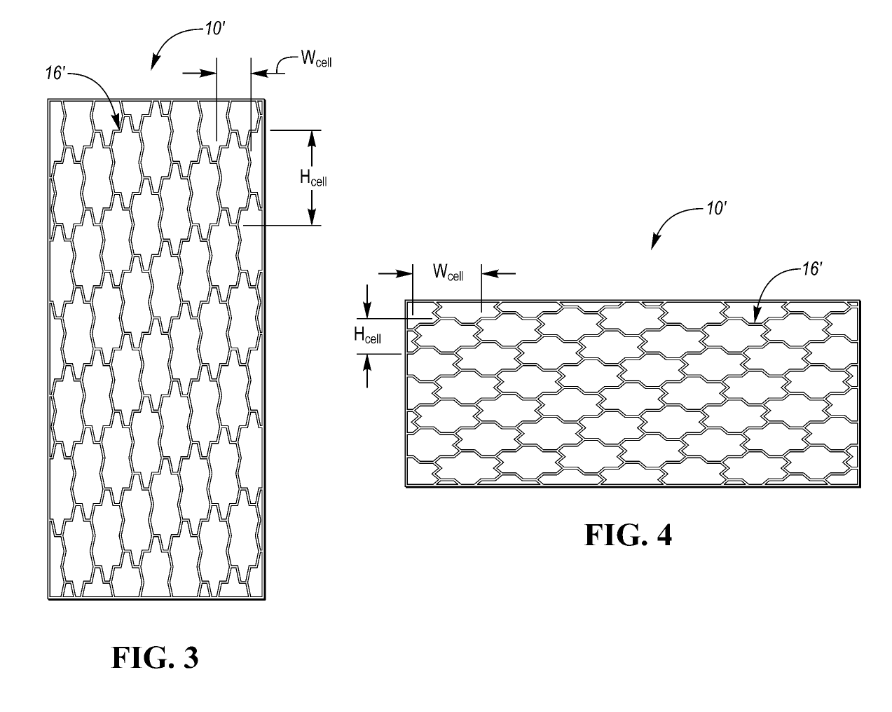

Referring to FIG. 3, a top view of a second embodiment of the cellular structure 10′ is illustrated. Unless otherwise stated herein, the second embodiment of the cellular structure 10′ should be construed to have all of the attributes of the cellular structure 10 described in FIGS. 1 and 2. The second embodiment of the cellular structure 10′ differs from cellular structure 10 in that each cell 16′ has a height, H_{cell}, that is greater than its width, W_{cell}. The skewed shape of the second embodiment of the cellular structure 10′ may result in the different lengths of the eighteen sides of each cell 16′ and non-symmetrical angles formed by the eighteen sides of each cell 16′. The cells 16′ of the second embodiment of the cellular structure 10′ are shown to maintain a symmetry where the left hand and right hand sides of each cell 16′ are mirror images of each other. It should be understood, however, that other embodiments may include cells having heights, W_{cell}, that greater than their widths, W_{cell}, where there is no symmetry between the left hand and right hand sides of each cell.

Referring to FIG. 4, a top view of a third embodiment of the cellular structure 10″ is illustrated. Unless otherwise stated herein, the third embodiment of the cellular structure 10″ should be construed to have all of the attributes of the cellular structure 10 described in FIGS. 1 and 2. The third embodiment of the cellular structure 10″ differs from cellular structure 10 in that each cell 16″ has a width, W_{cell}, that is greater than its height, W_{cell}. The skewed shape of the third embodiment of the cellular structure 10″ may result in the different lengths of the eighteen sides of each cell 16″ and non-symmetrical angles formed by the eighteen sides of each cell 16″. The cells 16″ of the third embodiment of the cellular structure 10″ are shown to maintain a symmetry where the top and bottom sides of each cell 16″ are mirror images of each other. It should be understood, however, that other embodiments may include cells having widths, W_{cell}, that greater than their heights, H_{cell}, where there is no symmetry between the top and bottom sides of each cell. It should further be understood that other embodiments may include cells that have widths, W_{cell}, that are equal to their heights, H_{cell}, but are however non-symmetrical in shape.

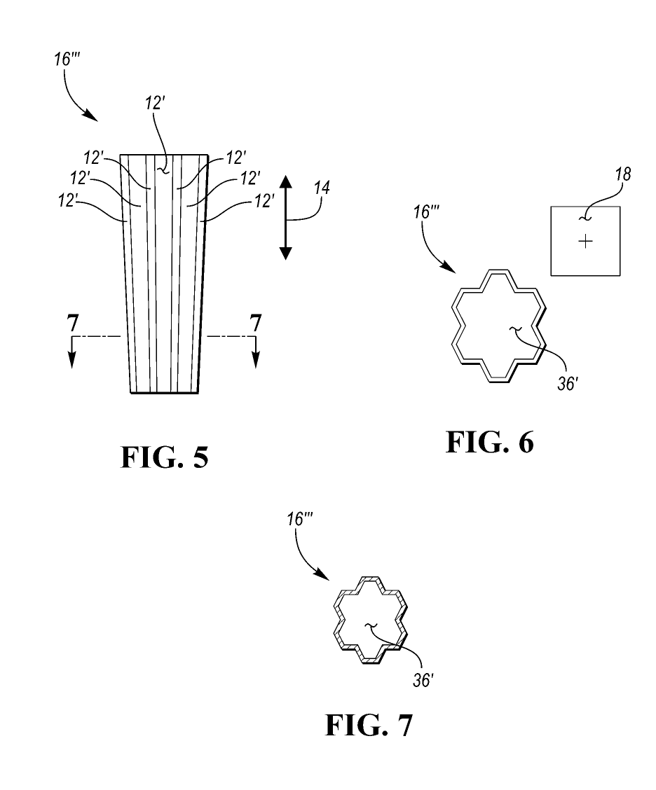

Referring to FIGS. 5-7, an alternative embodiment of the cellular structure 16″′ of the cellular structure 10 is illustrated. Unless otherwise stated herein, the alternative embodiment of the cellular structure 16″′ should be construed to have all of the attributes of the cells 16 described in FIGS. 1 and 2. The plurality of walls 12′ of the alternative embodiment of the cellular structure 16″′ taper in the longitudinal direction 14 such that a cross-sectional area of the central space 36′ defined by the eighteen sides of each cell decreases extending in the longitudinal direction 14.

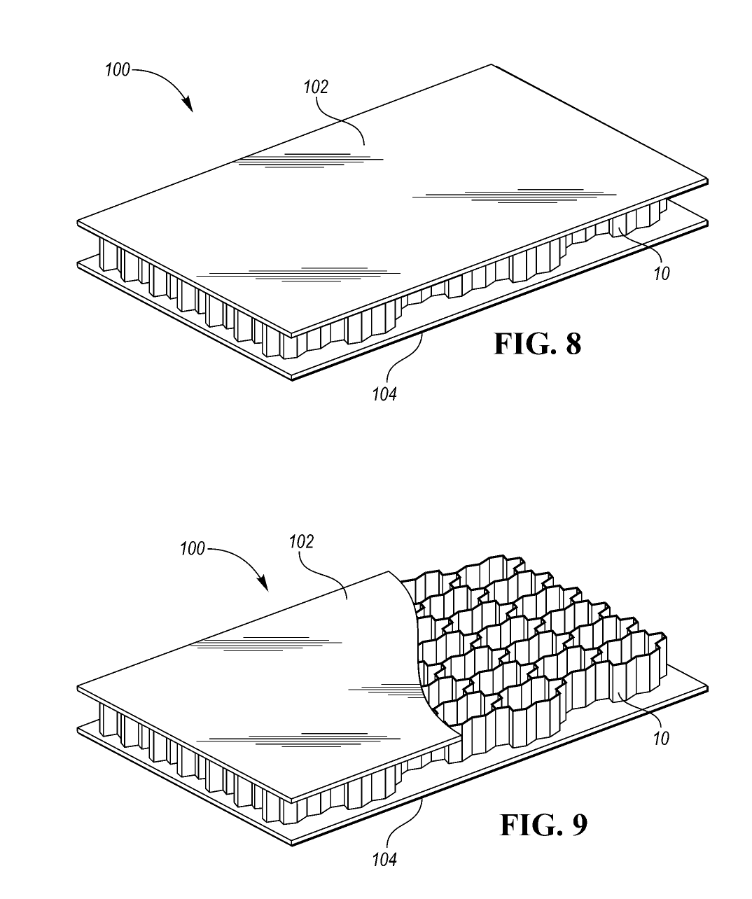

Referring to FIGS. 8 and 9, a sandwich structure 100 employing the cellular structure 10 is illustrated. The sandwich structure 100 has a core comprised of the cellular structure 10 with two substantially planar structures on opposing sides of the cellular structure 10 to form the sandwich structure 100. The cellular structure 10 is disposed between a top panel 102 and a bottom panel 104 in the sandwich structure 100. Top and bottom panels 102 and 104 may be in the form of any type of substantially planar structure. The substantially planar structures may be made of, for example, paper, wood, steel alloys, aluminum alloys, magnesium alloys, titanium alloys, polymers, or carbon or glass fiber reinforced composites. The substantially planar structures may be opaque, translucent, clear, etc. For example, one of the substantially planar structures may be clear or translucent to allow an observer of the product containing the cellular structure 10 to see a portion of the cellular structure 10, such that the cellular structure 10 forms a part of the aesthetic design of the product. The substantially planar structures may be formed integrally with the cellular structure 10 via conventional means such as molding and/or casting. Alternatively, the substantially planar structures may be bonded, coupled, or otherwise affixed to the cellular structure 10 via any conventional means, such as adhesion, lamination, mechanical fastening and/or welding.

The plurality of walls 12 that form the cellular structure 10, the plates 30 that are joined to the outside surfaces (if any), and the internal support ribs 32 may be made from steel alloys, titanium alloys, aluminum alloys, magnesium alloys, nylons, polymers, plastics, composites, fiber-reinforced composites, silicone, semiconductor materials, paper, carboard, shape-memory materials, rubber, foam, gel, hybrid materials (i.e., combinations of dis-similar materials), or any other suitable materials.

Each cell 16 size may be adjusted and can be optimized to meet different local or global property requirements. Layers and blocks of cellular structures with different cell sizes or materials can be also joined together to obtain different local or global properties based on the desired application and/or in anticipation of expected loads whether they be local or global. The same or different layers of cellular structures may be layered and adhered together with or without plates in between the layers. The cross-section can be tapered along the vertical axis (i.e., the longitudinal direction 14 or expected impact direction), as shown in FIG. 5.

The cellular structure 10 may be produced by stamping, bending, press forming, hydro-forming, molding, casting, extrusion, uniform or non-uniform roll forming, machining, forging, 3-D printing, or any other suitable manufacturing processes.

The cellular structure 10 may be utilized in the automotive industry to construct (1) integrated structures such as crush cans, front rails, mid rails, side rails, or rear rails (e.g. extruded aluminum rails, molded carbon fiber reinforced polymer/composite rails, etc.); (2) structural internal inserts and/or external energy absorbing devices such as rockers, A/B/C/D-pillars, shutguns, roof rails, bows, panels, cross-members, doors, floors, hoods, deck-lids, lift-gates, or any other load carrying/occupant protection device; (3) protective structures surrounding electric batteries; (4) plastic trim backing/reinforcement ribs or molding/casting parts that form backing/reinforcement ribs for components such as center consoles, HVAC systems, air ducts, arm rests, utility boxes, door trims, headliners, etc.; (5) energy absorbing devices for high performance and racing vehicles; or (6) deformable barriers.

The cellular structure 10 may be utilized in the aerospace, aeronautical, and defense industries to construct panels, floors, hulls, sub-structures for military or commercial aircrafts, space vehicles, space telescopes, space stations, or rockets.

The cellular structure 10 may be utilized in the train, locomotive, or high speed rail industries to construct interior linings, cab walls, interior doors, floors, roofs, or energy absorbing devices.

The cellular structure 10 may be utilized in the military, commercial, high speed vessel, and high-performance racing watercraft industries to construct components such as interior linings, cab walls, interior doors, floors, roofs, wing sails, or energy absorbing devices.

The cellular structure 10 may be utilized in the wind and solar energy industries to construct laminated skins for wind turbine blades, inserts for wind turbine blades, or backing structures for solar panels.

The cellular structure 10 may be utilized in various sporting good industries to construct snow boards, surf boards, skate boards, paddle boards, paddles, surfing fins, skis, gym floor cushions, seat cushions, fitness cushions, baseball/softball bases or plates, shoe insoles, shoe outsoles, shoe uppers, body impact protection, lightweight motor sport body armors (including inserts, protectors, pads), ping-pong and pickleball paddle pads, etc.

In the shipping and packaging industry, the cellular structure 10 may be utilized to construct paperboards or plastic boards used in package boxes, cushions, or pallets.

The cellular structure 10 may be utilized to construct furniture such as light weight furniture used in commercial and private aircrafts, high speed watercrafts, and recreational vehicles.

The cellular structure 10 may be utilized to construct home products such as mattresses, pillows, bath and floor cushions, and lightweight plastic shelving.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A cellular structure comprising:
a web of cells having shared walls, the cells each including six lobes that are formed by the shared walls and joined to each other to form a closed loop, each lobe having three planar sections forming two external corners and each cell having six internal corners formed by the ends of adjacent lobes.

2. The structure of claim 1, wherein the six lobes of each cell are radially spaced substantially evenly about a center of each cell.

3. The structure of claim 1, wherein the shared walls extend in one direction.

4. The structure of claim 3, wherein each cell has a cross-section that is oriented perpendicular to the one direction and an expected impact direction.

5. The structure of claim 1, wherein the web of cells is oriented to receive an impact from an impact direction, wherein the shared walls extend toward the impact direction when an impact is received.

6. A cellular structure comprising:
a plurality of walls extending in a longitudinal direction and forming a plurality of cells adjacently arranged along a laterally extending plane, each cell having a cross-section along the plane that includes eighteen sides formed by the plurality of walls, wherein the eighteen sides of each cell are joined to each other to form a closed loop and six outward extending lobes.

7. The structure of claim 6, wherein each lobe is formed by three of the eighteen sides of each cell.

8. The structure of claim 7, wherein the six lobes of each cell are radially spaced relative to each other about a center of each cell.

9. The structure of claim 8, wherein the six lobes of each cell are radially spaced substantially evenly about the center of each cell.

10. The structure of claim 6, wherein a ratio between a longitudinal length and a thickness of each the plurality of walls forming the plurality of cells is at least one to one hundred.

11. The structure of claim 6, wherein the plurality of walls taper in the longitudinal direction such that a cross-sectional area of a central space defined by the eighteen sides of each cell decreases extending in the longitudinal direction.

12. The structure of claim 6, wherein at least one cell of the plurality of cells includes an internal support rib disposed within a central space defined by the eighteen sides and secured to at least two of the eighteen sides of the at least one cell.

13. The structure of claim 6, wherein a central space defined by the eighteen sides of at least one of the plurality of cells is filled with a deformable foam material.

14. A cell structure comprising:
a plurality of walls extending in a longitudinal direction and forming a cross-sectional area on a laterally extending plane, the cross-sectional area including eighteen sides formed by the plurality of walls, wherein the eighteen sides are joined to each other to form a closed loop and six outward extending lobes.

15. The cell structure of claim 14, wherein each lobe is formed by three of the eighteen sides.

16. The cell structure of claim 15, wherein the six lobes are radially spaced relative to each other about a center of the cell.

17. The cell structure of claim 16, wherein the six lobes are radially spaced substantially evenly about the center of the cell.

18. The cell structure of claim 14, wherein a ratio between a longitudinal length and a thickness of each of the plurality of walls forming the cell is at one to one hundred.

19. The cell structure of claim 14, wherein the plurality of walls taper in the longitudinal direction such that the cross-sectional area decreases extending in the longitudinal direction.

20. The cell structure of claim 14 further comprising an internal support rib disposed within a central space defined by the eighteen sides and secured to at least two of the eighteen sides.
